(19) United States
(12) Patent Application Publication
(10) Pub. No.: US 2008/0127332 A1
(43) Pub. Date: May 29, 2008

(54) Information processing system, electronic authorization information issuing device, electronic information utilizing device, right issuing device, recording medium storing electronic authorization information issuing program, electronic information utilizing program and right issuing program, and information processing method

(75) Inventor: Yoshikazu Kawai, Tokyo (JP)

Correspondence Address: OLIFF & BERRIDGE, PLC, P.O. BOX 320850, ALEXANDRIA, VA, 22320-4850, US

(73) Assignee: FUJI XEROX CO., LTD., TOKYO (JP)

(21) Appl. No.: 11/802,063

(22) Filed: May 18, 2007

(30) Foreign Application Priority Data
Nov. 28, 2006 (JP) 2006-320380

(51) Int. Cl. G06F 7/04

(52) U.S. Cl. 726/21

(57) ABSTRACT

An information processing system which includes a right issuing unit that issues a right to utilize electronic information; an electronic authorization information issuing unit that issues electronic authorization information in which reference information indicating the right issued by the right issuing unit is set; a right acquisition unit that acquires the right issued by the right issuing unit based on the reference information set in the electronic authorization information issued by the electronic authorization information issuing unit; and an electronic information utilizing unit that utilizes the electronic information within a range of the right acquired by the right acquisition unit.

### CROSS-REFERENCE TO RELATED APPLICATION

This application is based on and claims priority under 35 USC 119 from Japanese Patent Application No. 2006-320380 filed on Nov. 28, 2006.

### BACKGROUND

1. Technical Field

The present invention relates to an information processing system, an electronic authorization information issuing device, an electronic information utilizing device, a right issuing device, a recording medium storing an electronic authorization information issuing program, an electronic information utilizing program and a right issuing program, and an information processing method.

2. Related Art

Recent development in computers, networks, and communication technologies has led to rapid increase in use of digital content (hereafter, referred to simply as “content”), while creating a situation in which duplication and distribution of the content can be performed very easily. To cope with such a situation, systems are proposed for copyright protection and prevention of information leak by protecting the content with encryption or the like and issuing an electronic ticket or license to legitimate users.

According to a conventionally proposed method, the validity of an issued electronic ticket is verified on a computer seeking to utilize content. If the validity is confirmed (if the ticket is not forged), the utilization of the content is allowed within the range of a right described on the electronic ticket (see FIGS. 10 and 11). The term “right” as used herein includes operation-related rights such as a right to view, print or edit the content, and general conditions for allowing the use of the content such as an available period, a number of uses, and users and groups allowed to utilize the content. In most of the cases, particulars of the right need not be hidden as long as the manipulation is prevented.

An electronic ticket contains a right together with a content decryption key, the right being set in accordance with user information when issuing the electronic ticket (see FIG. 12).

### SUMMARY

According to an aspect of the invention, there is provided an information processing system which includes a right issuing unit that issues a right to utilize electronic information; an electronic authorization information issuing unit that issues electronic authorization information in which reference information indicating the right issued by the right issuing unit is set; a right acquisition unit that acquires the right issued by the right issuing unit based on the reference information set in the electronic authorization information issued by the electronic authorization information issuing unit; and an electronic information utilizing unit that utilizes the electronic information within a range of the right acquired by the right acquisition unit.

### BRIEF DESCRIPTION OF THE DRAWINGS

An exemplary embodiment of the present invention will be described in detail based on the following figures, wherein:

FIG. 1 is a diagram illustrating an example of overall configuration of an information processing system according to the exemplary embodiment of the present invention;

FIG. 2 is a diagram illustrating an example of configuration of an electronic ticket;

FIG. 3 is a diagram showing a part of functional configuration of a client terminal 10 shown in FIG. 1;

FIG. 4 is a diagram showing a part of functional configuration of a ticket issuing server 20 shown in FIG. 1;

FIG. 5 is a showing a part of functional configuration of a right issuing server 30 shown in FIG. 1;

FIG. 6 is a diagram showing an image at the time of changing right information;

FIG. 7 is a first diagram showing a flow of processing in the information processing system shown in FIG. 1;

FIG. 8 is a second diagram showing a flow of processing in the information processing system shown in FIG. 1;

FIG. 9 is a diagram illustrating a modified embodiment according to the exemplary embodiment of the present invention;

FIG. 10 is a first diagram illustrating a related art;

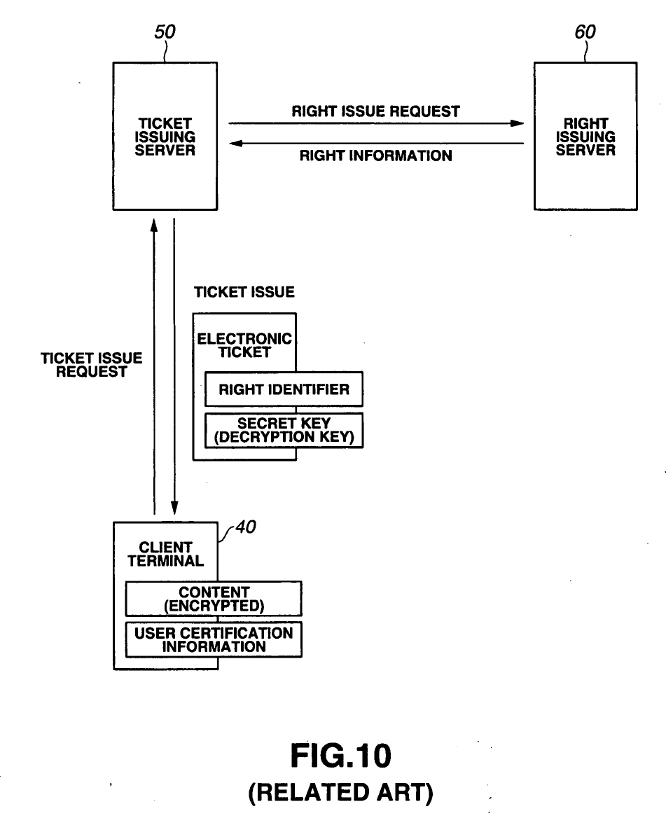

FIG. 11 is a second diagram illustrating a related art; and

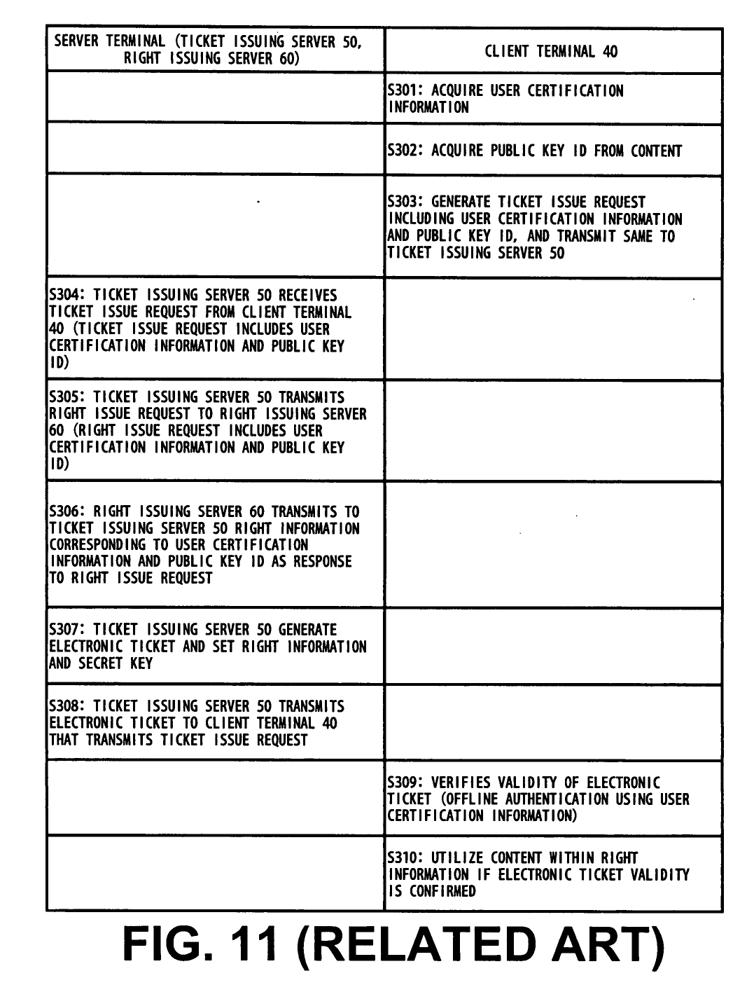

FIG. 12 is a third diagram illustrating a related art.

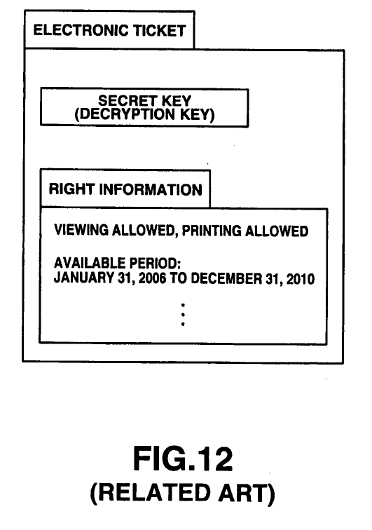

### DETAILED DESCRIPTION

With reference to the accompanying drawings, detailed description will be made of the exemplary embodiments of the present invention relating to an information processing system, an electronic authorization information issuing device, an electronic information utilizing device, a right issuing device, a recoding medium storing an electronic authorization information issuing program, an electronic information utilizing program and a right issuing program, and an information processing method.

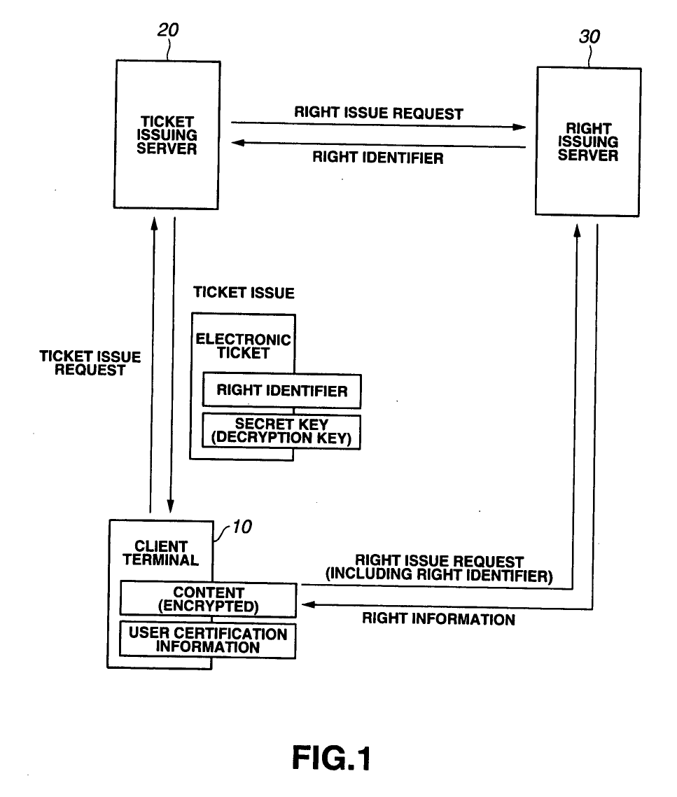

FIG. 1 is a diagram illustrating an example of overall configuration of an information processing system according to the exemplary embodiment of the present invention.

This information processing system has a client terminal 10, a ticket issuing server 20, and a right issuing server 30 which are mutually connected through a network such as LAN (Local Area Network) or WAN (Wide Area Network). Additionally, a content providing server or the like may be connected to the network if necessary. Each of these servers includes a CPU (Central Processing Unit) serving as a master control unit, a ROM (Read Only Memory) or a RAM (Random Access Memory) serving as main storage unit, a hard disk serving as a auxiliary storage unit, a keyboard and a mouse serving as an input/output interface, a display, an LAN board serving as an communication interface, and so on.

The client terminal 10 is a general-purpose computer operated by a user. The user utilizes various kinds of content on this terminal. For utilizing the content, the user is required to obtain an electronic ticket (electronic authorization information) issued by the ticket issuing server 20. The content is encrypted (encapsulated) with a public key.

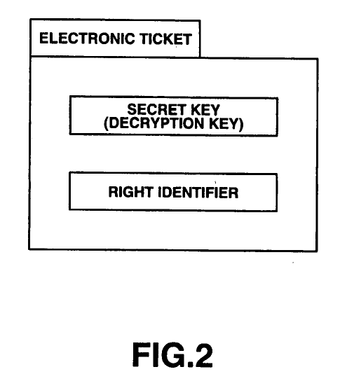

The ticket issuing server 20 implements a function to issue an electronic ticket in response to a ticket issue request from the client terminal 10. The electronic ticket has a function as a certificate to permit utilization of content. As shown in FIG. 2, reference information (a right identifier in this embodiment) indicating right information (information indicating particulars of the right) and a secret key for decrypting the content are set in the electronic ticket. This means that the right itself is not written in the electronic ticket.

The right issuing server 30 implements a function to issue a right. Specifically, the right issuing server 30 issues a right identifier in response to a right issue request from the ticket issuing server 20, and issues right information corresponding to the right identifier in response to a right issue request (containing the right identifier) from the client terminal 10. The term “right information” as used herein includes operation-related information such as a right to view, print, or edit the content, and general conditions for allowing the use of content such as an available period, a number of uses, and users and groups allowed to utilize the content.

A flow of processing to utilize the content will be briefly described.

An electronic ticket is required to utilize the content. Therefore, in the first step, a ticket issue request is transmitted from the client terminal 10 to the ticket issuing server 20. Upon receiving the request, the ticket issuing server 20 generates an electronic ticket, and transmits a right issue request to the right issuing server 30.

Upon receiving the request, the right issuing server 30 returns a right identifier as a response thereto. As described above, the right identifier is reference information indicating right information. Upon receiving the reference identifier, the ticket issuing server 20 generates an electronic ticket while setting the right identifier and a secret key (decryption key) for decrypting the content in the generated electronic ticket, and returns this electronic ticket to the client terminal 10 as a response to the ticket issue request.

The client terminal 10 then acquires the right identifier set in the electronic ticket, and acquires right information corresponding to the right identifier from the right issuing server 30. The acquisition of the right information is performed by the client terminal 10 transmitting a right issue request containing the right identifier to the right issuing server 30.

Upon acquiring the right information, the client terminal 10 performs offline authentication by using user certification information to verify the validity of the electronic ticket. If the verification determines the validity, the content is decrypted with the secret key set in the electronic ticket, and the user is allowed to utilize the content within the range specified by the right information.

These are the description of the overall configuration of the information processing system according to the exemplary embodiment of the present invention. However, the configuration of the information processing system shown in FIG. 1 is just an example and the present invention is not limited to this. For example, the functions performed by the ticket issuing server 20 and the right issuing server 30 may be packaged in one terminal. The right issuing server 30 may be a terminal of the content creator.

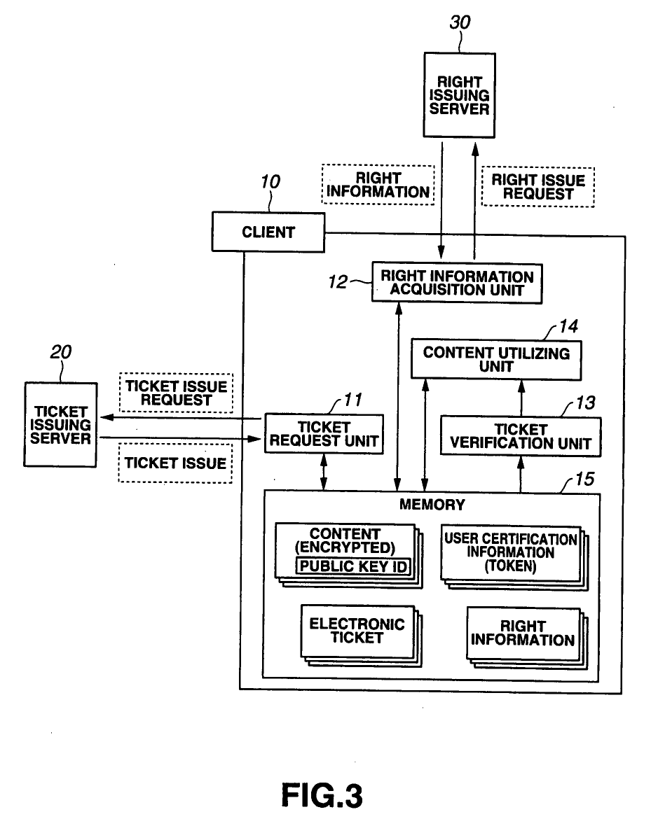

A description will be made of a part of functional configuration of the client terminal 10, the ticket issuing server 20, and the right issuing server 30. Firstly, the description will be made of the client terminal 10 with reference to FIG. 3.

The client terminal 10 includes processing function units, namely a ticket request unit 11, a right information acquisition unit 12, a ticket verification unit 13, a content utilizing unit 14, and a memory 15.

The ticket request unit 11 implements a function to request issue of an electronic ticket to the ticket issuing server 20. The request for issue of an electronic ticket is carried out by the ticket request unit 11 transmitting a ticket issue request to the ticket issuing server 20. The ticket issue request contains user certification information called token and a public key ID for identifying a public key.

The right information acquisition unit 12 implements a function to acquire right information from the right issuing server 30. The acquisition of right information is performed by the right information acquisition unit 12 transmitting a right issue request to the right issuing server 30. The right issue request contains a right identifier set in the electronic ticket. By transmitting this right issue request, the right information acquisition unit 12 is enabled to acquire right information corresponding to the right identifier from the right issuing server 30.

The ticket verification unit 13 implements a function to verify the validity of an electronic ticket. The electronic ticket verification is performed by offline authentication using user certification information. If the verification determines the validity of the electronic ticket, the user is allowed to utilize the content within the range specified by right information corresponding to the right identifier set in the electronic ticket. In contrast, if the validity of the electronic ticket is not determined due to manipulation thereof or the like, the user is prohibited from using the content.

The content utilizing unit 14 implements a function to utilize the content. The content is utilized within the range specified by right information corresponding to the right identifier set in the electronic ticket. For example, when viewing and printing are allowed in the right information, the user is allowed to view and print the content but not allowed to duplicate the content when utilizing the content.

The memory 15 implements a function to store various data. The memory 15 stores the content, the user certification information, the electronic ticket, the right information, and so on. The content is encrypted with a public key stored in the ticket issuing server 20, and can be decrypted with the secret key set in the electronic ticket corresponding to the content. The electronic ticket and the right information are issued by the ticket issuing server 20 and the right issuing server 30, respectively. These are the description of the processing functions of the client terminal 10.

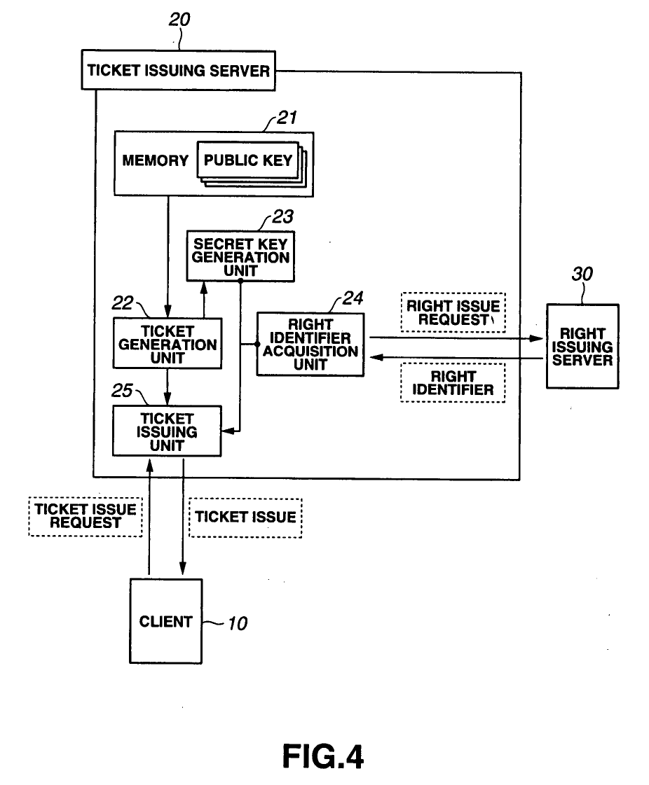

A description will be made of the ticket issuing server 20 with reference to FIG. 4.

The ticket issuing server 20 includes various processing function units, namely a memory 21, a ticket generation unit 22, a secret key generation unit 23, a right identifier acquisition unit 24, and a right issuing unit 25.

The memory 21 implements a function to store a public key. Each of the content is encrypted with the public key stored in the memory 21. A public key ID is incorporated in the content, and the public key is provided in association with the public key ID.

The ticket generation unit 22 implements a function to generate an electronic ticket. The electronic ticket is generated based on user certification information contained in a ticket issue request from the client terminal 10, and public key information of the public key corresponding to the public key ID.

The secret key generation unit 23 implements a function to generate a secret key for decrypting the content. The secret key is generated based on user certification information contained in a ticket issue request from the client terminal 10 and an electronic ticket generated by the ticket generation unit 22.

The right identifier acquisition unit 24 implements a function to acquire a right identifier from the right issuing server 30. The acquisition of the right identifier is performed by the right identifier acquisition unit 24 transmitting a right issue request to the right issuing server 30. The right issue request contains the user certification information and the public key ID contained in the ticket issue request from the client terminal 10.

The right issuing unit 25 implements a function to issue an electronic ticket. The issue of the electronic ticket is performed by setting the secret key generated by the secret key generation unit 23 and the right identifier acquired by the right identifier acquisition unit 24 in the electronic ticket generated by the ticket generation unit 22, and transmitting the electronic ticket to the ticket issue request source, or the client terminal 10. These are the description of the processing functions of the ticket issuing server 20.

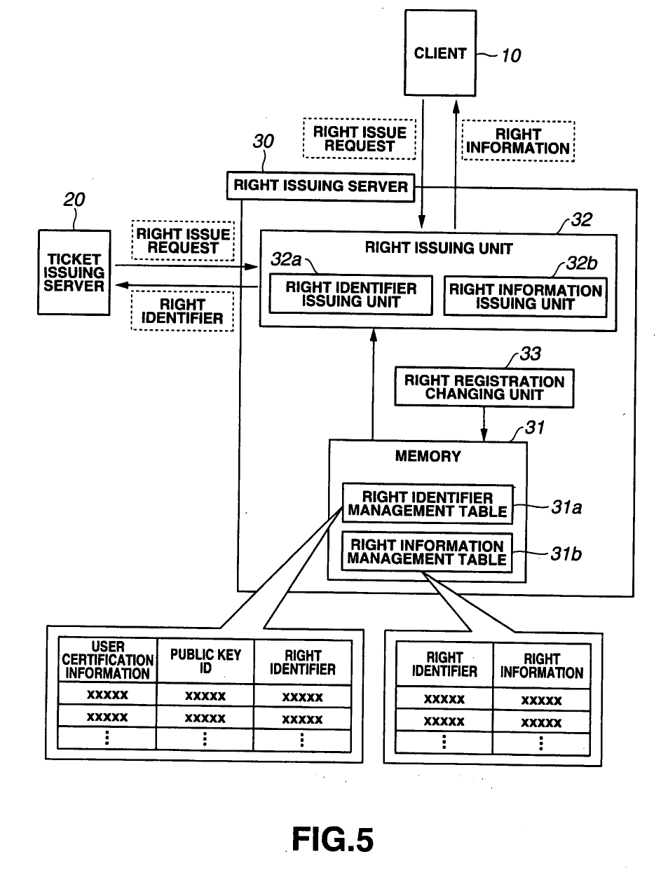

A description will be made of the right issuing server 30 with reference to FIG. 5.

The right issuing server 30 includes various processing function units, namely, a memory 31, a right issuing unit 32, and a right registration changing unit 33.

The memory 31 implements a function to store information relating to rights. The memory 31 stores a right identifier management table 31a for managing right identifiers in association with user certification information and public key IDs, and a right information management table 31b for managing right information in association with right identifiers.

The right issuing unit 32 implements a function to issue a right, and includes a right identifier issuing unit 32a that issues a right identifier in response to a right issue request from the ticket issuing server 20, and a right information issuing unit 32b that issues right information in response to a right issue request from the client terminal 10. The right identifier issuing unit 32a searches the right identifier management table 31a based on the user certification information and the public key ID contained in the right issue request from the ticket issuing server 10, and issues (returns) a right identifier corresponding to the user certification information and the public key ID. The right information issuing unit 32b searches the right information management table 31b based on the right identifier contained in the right issue request from the client terminal 10, and issues (returns) right information corresponding to the right identifier. A signature of the right issuing server 30 is applied to the right information issued by the right information issuing unit 32b.

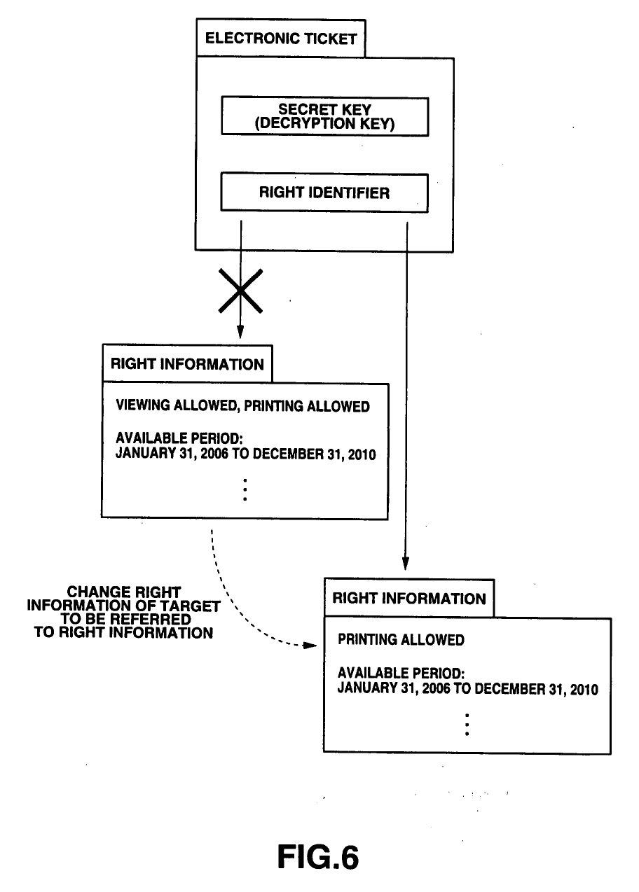

The right registration changing unit 33 implements a function to register or change the right information stored in the memory 33. The registration or change is performed based on an instruction given through an input unit (e.g., a keyboard or mouse) provided in the right issuing server 40, or on an instruction given by an external apparatus through the network. Even if the right information is changed by the right registration changing unit 33, as shown in FIG. 6, only the right information corresponding to the right identifier is changed. Therefore, the right identifier set in the electronic ticket will not be changed. These are the description of the processing functions of the right issuing server 30. Although the description above is made in terms of a case in which information relating to rights is preliminarily stored in the memory 31, it is also possible to generate a right identifier and right information dynamically in response to a right issue request from the ticket issuing server 20 or the client terminal 10.

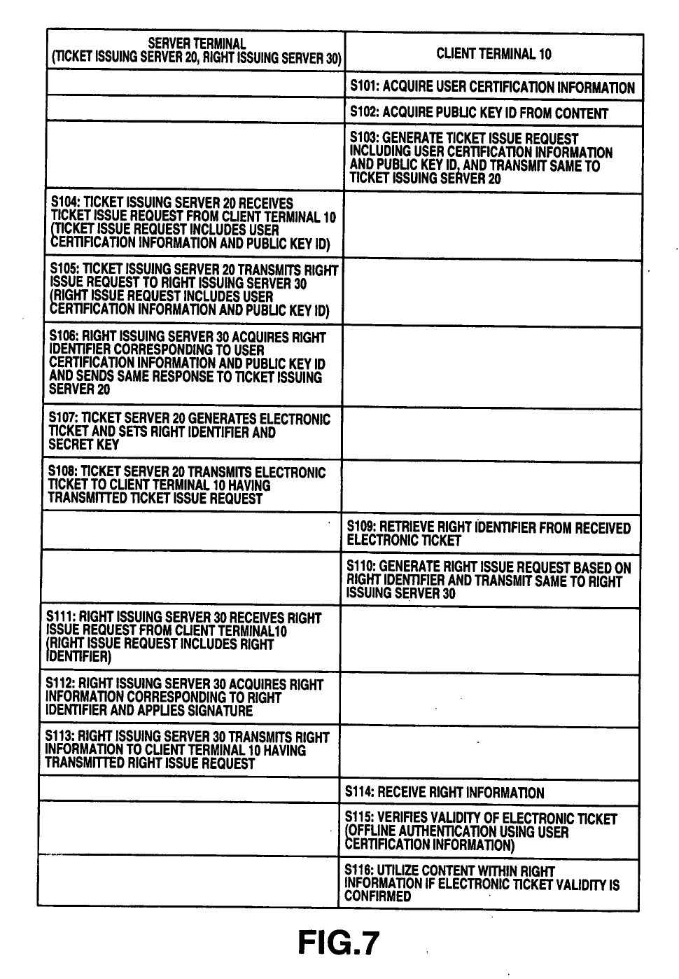

Operation of the information processing system shown in FIG. 1 will be described with reference to FIG. 7. The description here will be made of a flow of operation when the client terminal 10 utilizes content.

The client terminal 10 acquires user certification information (step S101), and acquires a public key ID from content to be utilized (step S102). The ticket request unit 11 generates a ticket issue request containing the user certification information and the public key ID and transmits the ticket issue request to the ticket issuing server 20 (step S103).

Upon receiving the ticket issue request (step S104), the ticket issuing server 20 acquires the user certification information and the public key ID from the request. The right identifier acquisition unit 24 then generates a right issue request containing the user certification information and the public key ID, and transmits this right issue request to the right issuing server 30 (step S105).

Upon the right issuing server 30 receiving the request, the right identifier issuing unit 32a acquires a right identifier corresponding to the user certification information and the public key ID, and returns this right identifier to the ticket issuing server 20 (step S106). The right identifier acquisition unit 24 thus acquires the right identifier corresponding to the user certification information and the public key ID.

After the ticket issuing server 20 acquires the right identifier, the ticket generation unit 22 generates an electronic ticket, while the secret key generation unit 23 generates a secret key for decrypting the content. Upon completion of the generation thereof, the right issuing unit 25 sets the right identifier and the secret key in the generated electronic ticket (step S107), and transmits this electronic ticket to the ticket issue request source, or the client terminal 10 (step S108).

Upon receiving the electronic ticket, the client terminal 10 retrieves the right identifier from the ticket (step S109). The right information acquisition unit 12 generates a right issue request containing this right identifier, and transmits the right issue request to the right issuing server 30 (step S110).

After the right issuing server 30 receives the right issue request (step S111), the right information issuing unit 32b retrieves the right identifier from the request, acquires right information corresponding to the right identifier, and applies a signature thereto (step S112). The right issuing server 30 then transmits the right information to the right issue request source, or the client terminal 10 (step S113).

After the client terminal 10 receives the right information (step S114), the ticket verification unit 13 verifies the validity of the electronic ticket (step S115). The verification is performed by offline authentication using the user certification information. If the verification determines the validity of the electronic ticket, the content utilizing unit 14 is allowed to utilize the content within the range specified by the right information (step S116).

These are the description of the flow of operation for utilizing the content. This processing operation is carried out only once before the first utilization of the content. For the following utilizations of the content, only the steps S115 and S116 are performed until expiration of the number of uses or the available period for the content indicated in the right information, or until expiration of the right. This is because the electronic ticket and right information once acquired are stored in the client terminal (in the memory 15) and the content is utilized within the range specified by the stored right information until expiration of the right. Accordingly, even if the right information is changed before the expiration of the allowed number of uses or available period, the change cannot be reflected.

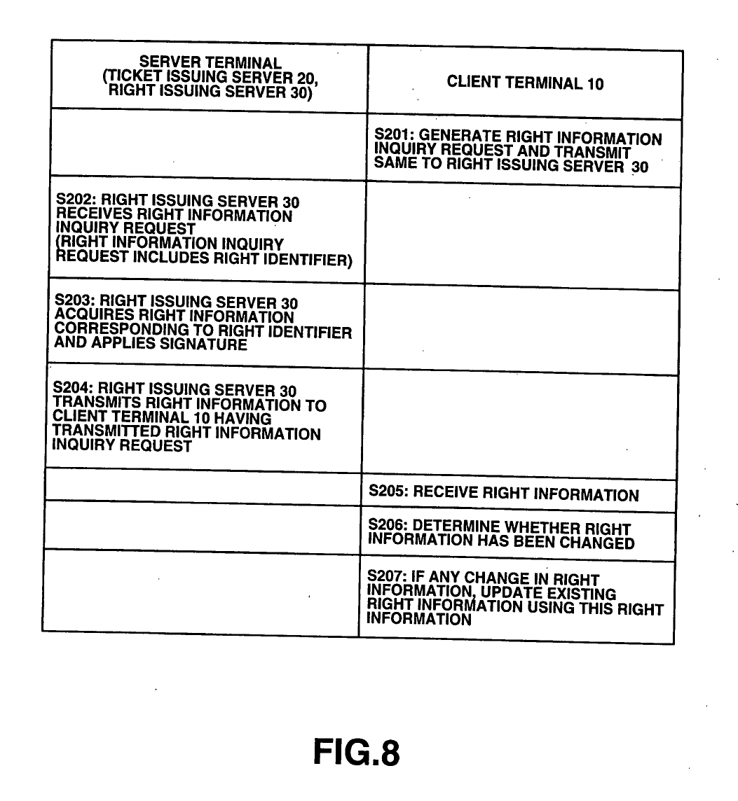

Referring to FIG. 8, a description will be made of operation for updating the right information. The description here will be made, as an example of the operation for updating the right information, in terms of a case in which the client terminal 10 makes inquiry about right information to the right issuing server 30. It is assumed that the client terminal 10 already holds content and an electronic ticket corresponding to the content.

The client terminal 10 generates a right information inquiry request containing a right identifier at the right information acquisition unit 12, and transmits the same to the right issuing server 30 (step S201). After the right issuing server 30 receives the inquiry request (step S202), the right information issuing unit 32b retrieves the right identifier from the request, acquires right information corresponding to the right identifier, and applies a signature thereto (step S203). The right issuing server 30 transmits this right information to the right issue request source, or the client terminal 10 (step S204).

The client terminal 10 receives the right information at the right information acquisition unit 12 (step S205), and determines whether or not the right information is changed from the existing right information (step S206). If any change, the client terminal 10 updates the existing right information (step S207).

These are the description of the operation for updating the right information. The updating of the right information can be performed at the timing when an instruction to utilize the content is given in the client terminal 10, or when the client terminal 10 is started up, for example. However, the timing is not limited to this. The updating of the right information may be performed by being notified, upon change in the right information, of the changed right information by the right issuing server 30. In this case, the right issuing server 30 may give such notification by using an electronic mail or the like.

While exemplary, representative embodiments of the present invention have been described, the present invention is not limited to the embodiments described above and shown in the drawings. It should be understood that various changes and modifications may be made without departing from the spirit and scope of the invention. Some of the possible modifications will be described below.

1) The issue of right information need not be performed at the time of issuing an electronic ticket. In other words, only the electronic ticket may be acquired first, and then the right information may be requested later. This is made possible by the fact that the right itself is not set in the electronic ticket.

2) Right information may be transmitted by a party setting the right through an e-mail or the like so that the user sets the same. This is made possible by the fact that the right itself is not set in the electronic ticket and, in many cases, particulars of the right information can be made public without any problem by its nature.

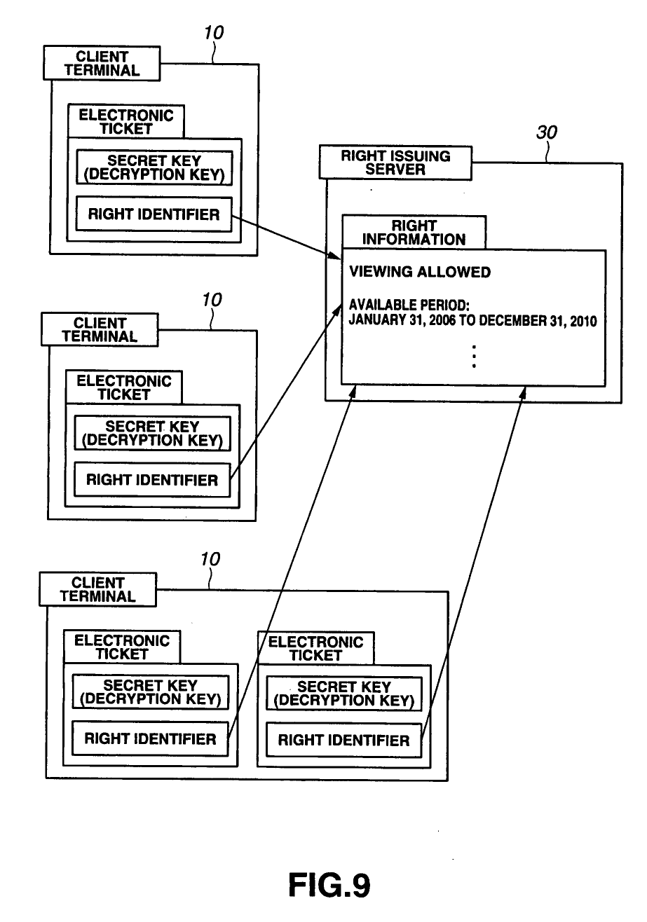

3) The right information may be associated with electronic tickets in one-to-many relationship. As shown in FIG. 9, when a same right is set for a plurality of electronic tickets, an identical right identifier is issued to those electronic tickets.

4) Although the embodiments above have been described in terms of a case in which a right identifier is used for reference information indicating right information, the reference information is not limited to this, but may be any information as long as it enables reference of the right information. For example, in addition to the right identifier, the reference information may contain a URL or the like indicating a terminal where the right information is stored.

5) Although the embodiments above have been described in terms of a case in which the client terminal 10 performs offline authentication using user certification information held in the terminal when verifying the validity of an electronic ticket, the validity of the electronic ticket may be verified by an external apparatus (online authentication).

6) The processing operations performed by the client terminal 10, the ticket issuing server 20, and the right issuing server 30 described in the embodiments above may be performed by a program installed in a computer. The program can be provided not only by communication unit such as a communication network, by also by storing the same in a recording medium such as a CD-ROM.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The exemplary embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing system comprising:
a right issuing unit that issues a right to utilize electronic information;
an electronic authorization information issuing unit that issues electronic authorization information in which reference information indicating the right issued by the right issuing unit is set;
a right acquisition unit that acquires the right issued by the right issuing unit based on the reference information set in the electronic authorization information issued by the electronic authorization information issuing unit; and
an electronic information utilizing unit that utilizes the electronic information within a range of the right acquired by the right acquisition unit.

2. The information processing system according to claim 1, wherein:
the electronic authorization information issuing unit acquires an identifier for identifying the right from the right issuing unit and issues electronic authorization information having the identifier set therein; and
the right acquisition unit acquires, from the right issuing unit, the right corresponding to the right identifier set in the electronic authorization information issued by the electronic authorization information issuing unit.

3. The information processing system according to Claim I, further comprising a memory that stores the right acquired by the right acquisition unit,
wherein the electronic information utilizing unit utilizes the electronic information within a range of the right stored by the memory.

4. The information processing system according to claim 3, wherein if there is any change in the right issued by the right issuing unit, the right acquisition unit acquires the changed right to update the right stored in the memory.

5. The information processing system according to claim 1, wherein the right is associated with reference information set in a plurality of items of electronic authorization information in one-to-many relationship.

6. An information processing system comprising:
a right issuing device that issues a right to utilize electronic information;
an electronic authorization information issuing device that issues electronic authorization information; and
an electronic information utilizing device that utilizes the electronic information,
the right issuing device including:
a right information issuing unit that issues right information indicating particulars of the right; and
a right reference information issuing unit that issues reference information indicating the right information,
the electronic authorization information issuing device including:
a reference information acquisition unit that acquires the reference information indicating the right information issued by the right reference information issuing unit; and
an electronic authorization information issuing unit that issues electronic authorization information in which the reference information acquired by the reference information acquisition unit is set,
the electronic information utilizing device including:
a right information acquisition unit that acquires the right information issued by the right information issuing unit based on the reference information set in the electronic authorization information issued by the electronic authorization information issuing unit; and
an electronic information utilizing unit that utilizes the electronic information within a range specified by the right information acquired by the right information acquisition unit.

7. An electronic authorization information issuing device comprising:
an electronic authorization information generation unit that generates electronic authorization information;
a reference information acquisition unit that acquires reference information indicating a right from a right issuing device; and
an electronic authorization information issuing unit that issues electronic authorization information after setting the reference information acquired by the reference information acquisition unit in the electronic authorization information generated by the electronic authorization information generation unit.

8. An electronic information utilizing device comprising:
an electronic authorization information request unit that requests issue of electronic authorization information;
a right acquisition unit that acquires a right from a right issuing device based on reference information indicating the right set in the electronic authorization information issued in response to the request by the electronic authorization information request unit;
a verification unit that verifies validity of the electronic authorization information issued in response to the request by the electronic authorization information request unit; and
an electronic information utilizing unit that utilizes the electronic information within a range of the right acquired by the right acquisition unit when the verification unit determines the validity of the electronic authorization information.

9. The electronic information utilizing device according to claim 8, further comprising a memory that stores the right acquired by the right acquisition unit,
wherein the electronic information utilizing unit utilizes the electronic information within a range of the right stored by the memory, and
if there is any change in the right issued by the right issuing device, the right acquisition unit acquires the changed right to update the right stored in the memory.

10. A right issuing device comprising:
a reference information issuing unit that issues reference information for right information indicating particulars of a right in response to a request from an electronic authorization information issuing device; and
a right information issuing unit that issues right information corresponding to the reference information set in electronic authorization information issued by the electronic authorization information issuing device.

11. A computer readable recording medium storing an electronic authorization information issuing program for causing a computer to execute a process, the process comprising:
generating electronic authorization information;
acquiring reference information indicating a right; and
issuing electronic authorization information after setting the acquired reference information in the generated electronic authorization information.

12. A computer readable recording medium storing an electronic information utilizing program for causing a computer to execute a process, the process comprising:
requesting issue of electronic authorization information;
acquiring a right based on reference information that indicates the right and that is set in the electronic authorization information issued in response to the request;
verifying validity of the electronic authorization information issued in response to the request; and
utilizing the electronic information within a range of the acquired right when the validity of the electronic authorization information is determined.

13. A computer readable recording medium storing a right issuing program for causing a computer to execute a process, the process comprising:
issuing, in response to a request for issue of reference information for a right information indicating particulars of a right, the reference information for the right information; and
issuing the right information corresponding to the reference information set in issued electronic authorization information.

14. An information processing method comprising:
issuing a right to utilize electronic information;
issuing electronic authorization information in which reference information indicating the issued right is set;
acquiring the issued right based on the reference information set in the issued electronic authorization information; and
utilizing the electronic information within a range of the acquired.
